(19) United States
(12) Patent Application Publication
(10) Pub. No.: US 2009/0034756 A1
(43) Pub. Date: Feb. 5, 2009

(54) SYSTEM AND METHOD FOR EXTRACTING ACOUSTIC SIGNALS FROM SIGNALS EMITTED BY A PLURALITY OF SOURCES

(76) Inventors: Arno Willem F. Volker, Delft (NL); Arjan Mast, Rotterdam (NL); Matthijs Pieter De Graaff, Nootdorp (NL)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/993,593

(22) PCT Filed: Jun. 23, 2006
(86) PCT No.: PCT/NL2006/000310

§ 371 Date: Mar. 17, 2008

(30) Foreign Application Priority Data
Jun. 24, 2005 (EP) 05076462.0

(51) Int. Cl. H04B 1/00

(52) U.S. Cl. 381/119

(57) ABSTRACT

A system for extracting one or more acoustic signals from a plurality of source signals emitted by a plurality of sources, respectively, in an environment, the system comprising an array of microphone receivers for receiving the one or more acoustic signals from the environment and transmitting the signal to a signal processor, wherein the signal processor is arranged to estimate the plurality of source signals using the data received by array of receivers, the signal processor is further arranged to perform an operation on the data received by the array of receivers with the estimated source signals to provide an estimate of the impulse response of the environment, wherein the data received by the array of receivers is input to the estimate of the impulse response of the environment to provide an output comprising a plurality of channels, wherein one or more of the channels correspond to the one or more acoustic signals from one of the plurality of sources, respectively.

### TECHNICAL FIELD

The invention relates to a system for extracting one or more acoustic signals from a plurality of source signals emitted by a plurality of sources and a method of extracting one or more acoustic signals from a plurality of source signals emitted by a plurality of sources.

### BACKGROUND TO THE INVENTION AND PRIOR ART

In an environment where there are a plurality of acoustic signals originating from a plurality of sources, some techniques have been proposed to locate or track one of the acoustic source signals.

In the field of conferencing, for example, sources, such as speakers, may be located using a microphone array. Conventional techniques include “beamforming” which includes storing data in a computer and applying time delays and summing the signals. In this way the microphone array is able to “look” in different directions in order to localize the sources. In an alternative prior art technique, an array may be arranged in a particular geometry in order to achieve a degree of directionality. The direction with the highest energy is determined as being the direction of the speaker. By listening to the speaker from a variety of angles, his position can be determined. It has been found that this technique works satisfactorily to locate one speaker in a room which is only slightly reverberant. The speech signal from the one speaker may be improved by focussing, that is to say, the signals from the individual microphones are shifted in time and summed (constructive interference) in order to weaken undesired signals. In this way, the signal to noise ratio is improved, This technique, however, typically gives an improvement of only around 14 dB for two substantially equal signals, i.e. the separation between the speaker's signal and the undesired signals is around 14 dB and, after processing, the undesired signal is approximately 14 dB weaker.

It has been found, for example, that such a performance it not sufficient if the located signal is to be fed to another application, such as a speech recognition system. Further, it has been found that using conventional techniques, it is not possible to locate, track and extract one or more signals originating from different sources int a reverberant, partially reverberant or non-reverberant environments. In particular, the location, tracking and extraction of acoustic signals from a reverberant environment remains unsatisfactory.

It is an object of the present invention to address those problems encountered using conventional locating, tracking and extracting techniques.

In particular, it is an object to locate, track and extract one or more signals in a reverberant, partially reverberant or non-reverberant environment.

### SUMMARY OF THE INVENTION

According to a first aspect of the invention, there is provided a system for extracting one or more acoustic signals from a plurality of source signals emitted by a plurality of sources, respectively, in an environment, the system comprising a plurality of microphone receivers for receiving the one or more acoustic signals from the environment and transmitting the signal to a signal processor, wherein the signal processor is arranged to estimate the plurality of source signals using the data received by the plurality of receivers, the signal processor is further arranged to perform an operation on the data received by the plurality of receivers with the estimated source signals to provide an estimate of the propagation operator of the environment, wherein the data received by the plurality of receivers is input to the estimate of the impulse response of the environment to provide an output comprising a plurality of channels, wherein one or more of the channels correspond to the one or more acoustic signals from one of the plurality of sources, respectively.

In this way, one or more acoustic signals present in an environment (reverberant or not) can be localised, tracked and separated from one another. In one embodiment, the propagation operator is described as a direct wave. In a further embodiment, the propagation operator is described as an impulse response. By estimating the impulse response of the environment, the environment is acoustically determined, so that when the data received from the array of receivers is input into the impulse response (the acoustic determination of the environment), any reflections, which would conventionally be regarded as noises are taken into account in the signal processing. Because the impulse response of the environment is estimated, it is no longer an issue whether or not the environment is reverberant or not, because the impulse response automatically takes any reverberant characteristics of the environment into account. Further, by estimating the impulse response of the environment, the Green's function corresponding to the source or sources of the one or more acoustic signals may be approximated. In this way, the behaviour of the plurality of sources in the environment can be accurately determined and taken into account in the extraction of the one or more acoustic signals. It has been found that according to the invention, the extraction of the one or more acoustic signals means in fact, that the time signals of any other signals are provided separately from the extraction. In particular, it has been found that the level of the other signals on the channel or channels for the one or more extracted signals is at least 25 dB lower. Further, in this way, more than one acoustic signal can be extracted at the same time, because by estimating the source signals and using the estimate to estimate the impulse response, each source signal can be processed independently. In this way, an improved noise suppression is achieved. Further, a plurality of sources can be localized simultaneously. Further, in order to localize and extract the sources, it is not necessary to define the geometry of the room. Further, because each extracted signal is assigned a unique channel, the origin of each signal with respect to its source can be clearly identified with good resolution and accuracy.

In a further embodiment, the operation is to deconvolve the data received by the array of receivers with the estimated source signals. In this way, the impulse response is accurately estimated. In particular, the Green's function of the sources can be accurately estimated.

In a further embodiment, the one or more acoustic signals are extracted simultaneously. In this way, in real time it is possible to extract a plurality of signals at the same time. Thus, a time saving is achieved. Further, the location and tracking of a plurality of acoustic signal may also be achieved simultaneously.

In a further embodiment, the signal processor is arranged to locate a plurality of source locations of at least one of the plurality of sources for a plurality of time intervals, respectively, the system further comprising a memory for storing the plurality of source locations for the respective time intervals. Further, the signal processor is arranged to track one or more moving sources by repeatably locating the one or more moving sources for at least one of a plurality of time intervals and partially overlapping time intervals. Yet further, the stored location data may be used to track a particular source and to register which source is emitting the one or more acoustic signal at which position in space and during which time interval. In this way, the location and tracking of the sources is achieved in one measurement from the array of receivers, yet further improving the efficiency with which the data from the arrays is used.

In a further embodiment, the sources are located using inverse wavefield extrapolation to form an image. Further, the signal processor may be arranged to find the plurality of sources in the image. In this way, the location of the sources can be located in the spatial domain.

In a further embodiment, the inverse wavefield extrapolation is carried out with a predetermined range of frequency components at the higher end of the frequency range of the one or more signals. By selecting a high frequency range a high resolution is achieved. In this way, it has been found that the accuracy of the location of the sources is improved. Optionally, interpolation may be used to achieve a more accurate estimate of the source location. Further, by using a predetermined range of frequency components, the speed of the tracking algorithm can be improved.

In a further embodiment, the inverse wavefield extrapolation is carried out in the wavenumber-frequency domain. In this way, the efficiency of the data processing is improved.

In a further embodiment, the one or more acoustic signals are extracted by inputting the data received from the array with the estimate impulse response and carrying out a least squares estimation for the plurality of sources. In this way, the output is improved because the least squares estimation inversion takes into account the energy of the reflections, deteriorating the focussing result, in the estimation of the source signal.

In a further embodiment, at least one of the plurality of channels is input to an application, Further, the application may be at least one of a speech recognition system and speech recognition system. In this way, the speech recognition and speech control systems are improved by virtue of their improved input.

According to a second aspect of the invention, there is provided a method of extracting one or more acoustic signals from a plurality of source signals emitted by a plurality of sources, respectively, in an environment, wherein a signal processor is arranged to receive the one or more acoustic signals from the environment from a plurality of microphone receivers which transmit the signal to the signal processor, the method comprising estimating the plurality of source signals using the data received by the plurality of receivers, performing an operation on the data received by the plurality of receivers with the estimated source signals to provide an estimate of a propagation operator of the environment and

inputting the data received by the plurality of receivers into the estimate of the propagation operator of the environment to provide an output comprising a plurality of channels, wherein one or more of the channels correspond to the one or more acoustic signals from one of the plurality of sources, respectively.

According to a third aspect of the invention, there is provided a user terminal comprising means operable to perform the method of claims 19-31.

According to a fourth aspect of the invention, there is provided a computer-readable storage medium storing a program which when run on a computer controls the computer to perform the method of claim 19-31.

### BRIEF DESCRIPTION OF THE DRAWINGS

In order that the invention may be more fully understood embodiments thereof will now be described by way of example only, with reference to the figures in which:

FIG. 1 shows a system according to all embodiment of the present invention;

FIG. 2a shows a flow diagram of a method according to an embodiment of the present invention;

FIG. 2b shows a flow diagram of a method according to a further embodiment of the present invention;

FIG. 3 shows a wave field extrapolation according to an embodiment of the present invention;

FIG. 4 shows examples of inverse wave field extrapolation according to an embodiment of the present invention;

FIG. 5 shows an example of wave field extrapolation and source localization according to an embodiment of the present invention;

FIG. 6 shows an example of a source localization according to one embodiment of the invention using a) all frequencies and according to a further embodiment of the invention using b) the high frequencies only;

FIG. 7 shows a delay and sum technique according to an embodiment of the present invention;

FIG. 8 shows an example of a delay and sum technique used in accordance with an embodiment of the present invention;

FIG. 9 shows an example of a delay and sum technique used in a conventional technique, and

FIG. 10 shows an impulse response of a source in an enclosed environment according to an embodiment of the present invention.

Like reference symbols in the various figures indicate like elements.

### DESCRIPTION OF THE PREFERRED EMBODIMENTS

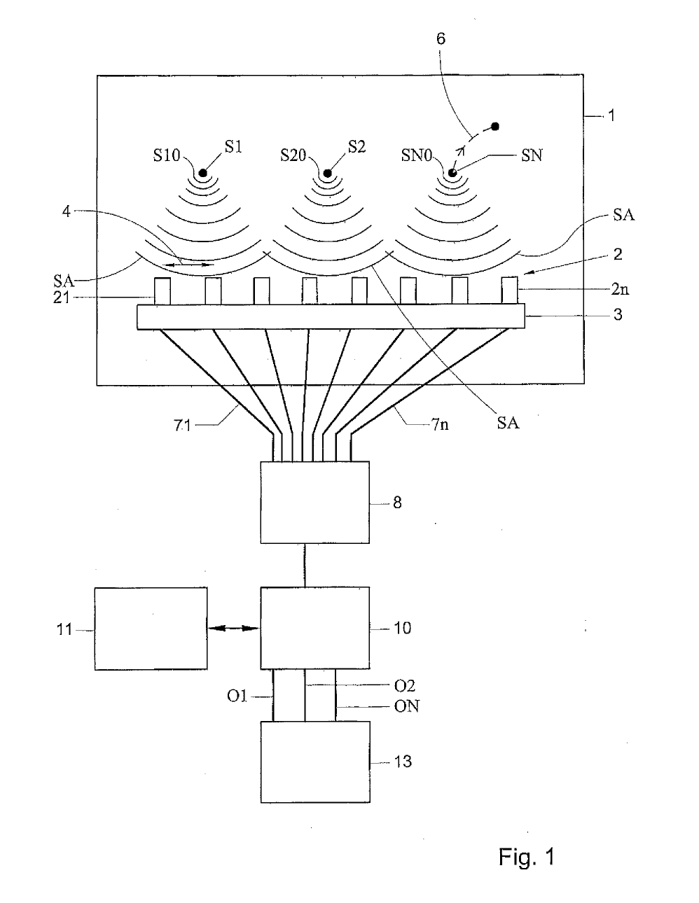

FIG. 1 shows a system according to an embodiment of the present invention. The invention has application in various environments including, but not limited to, hospital operating theatres, underwater tanks, wind tunnels and audio/visual conferencing rooms, theatre systems, entertainment systems, car audio systems, car telephone systems, etc. The invention also has application in the area of non-destructive testing. In particular, the invention has application to situations where there is a plurality of speakers in a room, where it is not possible using conventional techniques to track these speakers accurately on the basis of their own vocal sounds, and to distinguish the different speakers from one another. A further application is under water noise measurement, where due to the emergence of a resonant field, the localisation, tracking and separation of the different sources is not possible using conventional techniques. A further application is in wind tunnels and other enclosed volumes where reflections from the walls render localisation, tracking and separation impossible using conventional techniques. The invention has application to acoustic signals from a variety of acoustic sources including, but not limited to, audio and ultrasound.

FIG. 1 shows a plurality of sources S1, S2 . . . SN. The sources are disposed in an environment 1. The environment 1 may be reverberant, non-reverberant or partially reverberant. The environment 1 may be open or enclosed, for example a room or the like. The sources S1, S2 . . . SN emit a plurality of respective source signals S10, S20, SN0. The source produces a sound wave. The sound wave may be a transmitted vibration of any frequency. The sources may include any source, for example, a speaker in the room or the sounds from a machine. The source may also be a source of noise, for example, the sound of an air conditioning unit, In the embodiment shown in FIG. 1 is described with reference to audio sources in a reverberant room. Further, the sources may be stationary. However, they may also move, as shown by arrow 6 in FIG. 1. The movement of the sources is not limited within the environment 1. The source signals S10, S20, SN0 are transmitted through the environment 1. Also disposed in the environment 1 is a plurality of microphone receivers 2. In one embodiment, the plurality of receivers is arranged in one or more arrays. In particular, using a least squares inversion, described in more detailed hereinbelow, to obtain the source signal, a plurality of receivers is provided. In a further embodiment for localizing the sources an array of receivers is provided, The microphones 2 may be mounted on a beam 3. Typically, the array is linear. The spacing 4 between the microphones 2 is chosen in accordance with the frequency range of the source signals S10, S20, SN0. For example, the higher the frequency range of the source signals, the closer together the microphones are disposed. The array of microphones 2 receives the one or more acoustic signal SA. The acoustic signal SA is the signal which is to be extracted from other signals in the environment. Each microphone 21 . . . 2n provides an output 71 . . . 7n to a data collector S. The data collector typically includes an analogue to digital converter for converting the analogue acoustic signal to a digital signal. The digital signal is subsequently processed. The data collector S further typically includes a data recorder. The data collector 8 provides a digital output to a signal processor 10. The signal processor 10 may be in communication with a memory 11 in which data may be stored. The signal processor 10 provides outputs O1, O2 . . . ON on various output channels. The output channel O1 corresponds to the acoustic signal from source S1, the output channel O2 corresponds to the acoustic signal from source S2 and the output channel ON corresponds to the acoustic signal from source SN, etc. The outputs O1, O2 . . . ON may subsequently be provided to an application, such as a speech recognition application, or the like depending on the particular nature of the sources and the environment in which they are located.

In particular, the signal processor 10 is arranged to process the acoustic signal, as provided by the data collector in a digital form, so that the one or more acoustic signal SA is tracked and separated from other acoustic signals SA. The signal processing method is carried out by the signal processor 10. Typical signal processors 10 include those available from Intel, AMD, etc.

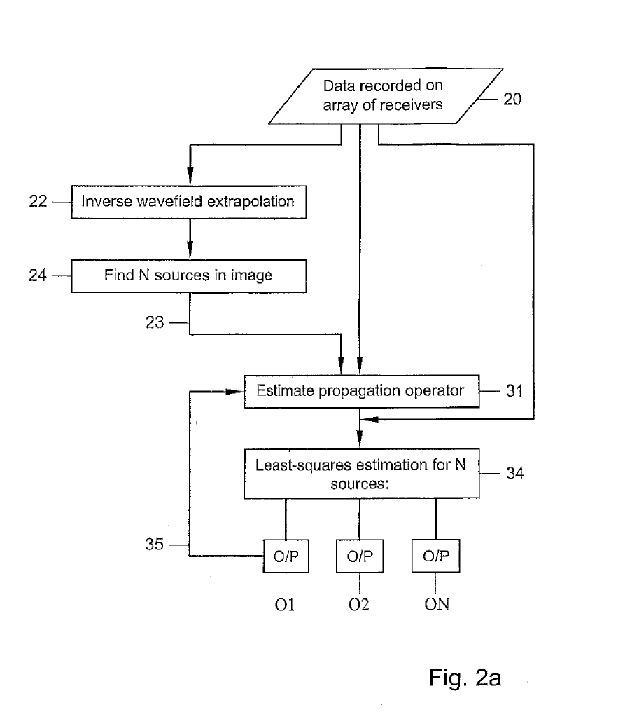

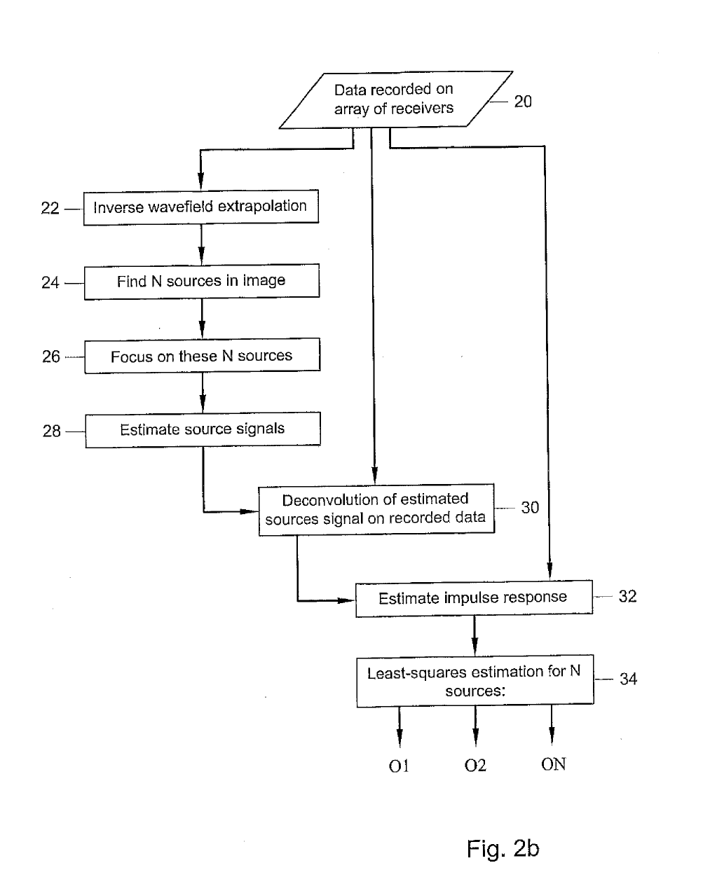

A schematic overview of two methods according to embodiments of the present invention are shown in FIGS. 2a and 2b. In particular, FIGS. 2a and 2b show a schematic overview of methods according to embodiments of the invention to localize and track sources. Further, from each source the speech signal is extracted using a least squares estimator. In the embodiment shown in FIG. 2a, a plurality of receivers is provided. In the embodiment shown in FIG. 2b, an array of receivers is provided. As mentioned above, the data received from the plurality of microphones or microphone array 2 is provided to the signal processor. This data is made available to the signal processor (step 20).

The method of tracking and extracting speech-signals of a plurality of persons, that is sources S1, S2, SN in a noise environment 1 uses wave theory based signal processing. An array of receivers 2 records the (speech) signals. Using inverse wavefield extrapolation (step 22) the locations of the several sound sources S1, S2 . . . SN present in the room 1 can be estimated with respect to the array (step 24). This allows tracking of the plurality of sources S1, S2 . . . SN throughout the room 1.

Once the locations are a first estimate of the sound signal from one source may be obtained by focussing (step 26), for example, using a delay and sum technique. This may be repeated for the plurality of sources. This first estimate (step 28) of the speech signal is used to determine a propagation operator for the room. The propagation operator describes the wave propagation from one point to another. The user can define the operator to include certain parameters. For example, the propagation operator may include zero wall reflections. In which case, the operator estimated is that for a direct wave. This embodiment is shown in FIG. 2a. Alternatively, the propagation operator may include 1^{st} wall reflections, 2^{nd} wall reflections, etc. By including reflections or reverberations, an impulse response for the environment is estimated. This embodiment is shown in FIG. 2b.

In one embodiment, as shown in FIG. 2a, the propagation operator is estimated for the direct wave, in other words, the first arrival without taking into account any reflections in the room. In an alternative embodiment, as shown in FIG. 2b the impulse response is the room's Green's function. The impulse response may be determined by performing an operation on the data received by the array of receivers with the estimated source signals to provide an estimate of the impulse response of the environment. The operation may be done by deconvolution (step 30) of the recorded signal received from the microphone array 2 with the estimated signal from step 28. The deconvolution transforms the speech-signal into a short pulse. After deconvolution it is possible to identify the different wave fronts in the recorded signal, both primary signals and multiple reflections can be identified. The information about the impulse response of the room is used in a least squares estimation based inversion (step 34) to extract the pure speech-signals O1, O2 . . . ON for a number of sources S1, S2 . . . SN from the data. This yields high quality signals for the different sources. Simulation results show that a suppression of undesired signals up to 25 dB is readily achieved, while conventional delay and sum methods only achieve a suppression of approximately 14 dB.

It is commented that the focussing step 26 is optional and that a certain focussing effect is achieved in the localizing step 22, by carrying out an inverse wavefield extrapolation. In particular, in the embodiment in which the propagation operator is the direct wave, as shown in FIG. 2a, it is not necessary to carry out focussing step 26. In this embodiment, as shown in FIG. 2a, the processor goes from step 24 directly to the step of estimating the propagation operator (step 31), as indicated by arrow 23. It is commented that the extraction of the signals by a deconvolution in space, is for example, carried out by the least square estimation of the N sources (step 34), is the same regardless of whether the propagation operator is the direct wave or the Green's function.

In a further embodiment, the processing may be carried out iteratively (step 35), in which at least one of the outputs O1, O2 . . . ON are fed back to step 30, the deconvolution of estimated source signal on recorded data. In this way, the result is improved.

Details of the processing carried out by the signal processor 10 are now described:

### Source Tracking (Steps 22 to 28)

The first step in tracking the sources S1, S2 . . . SN is to localize the plurality of sources S1, S2 . . . SN present in the room 1 (steps 22, 24). Once localized, the sources S1, S2 . . . SN can be tracked in time. The data recorded on the array of receivers 2 is used to localize the origins of the incoming wave fields (the sources). This technique is known as ‘inverse wave field extrapolation’.

### Wave Field Extrapolation (Step 22)

Extrapolation of wave fields in the field of seismology is described in A. J. Berkhout, Applied Seismic Wave Theory (Elsevier, Amsterdam 1987). In brief, the technique is based on the Rayleigh II integral,

$$P ( {x}_{1} , {y}_{1} , {z}_{1} , ω ) = \frac{jk}{2 π} {\int }_{- ∞}^{∞} {\int }_{- ∞}^{∞} P ( {x}_{0} , {y}_{0} , {z}_{0} , ω ) \times [ \frac{1 + jk Δ r}{jk Δ r} ] cos ϕ \frac{{e}^{- j k Δ r}}{Δ r} d x d y , \qquad ( 1 )$$

where j is the imaginary unit (√−1), k is the wavenumber (=ω/c=2 πf/c), f is the frequency [Hz] and c the speed of sound in the medium, P(x₀,y₀,z₀,ω) is the sound pressure at x₀,y₀,z₀ for the single frequency ω and P(x₁,y₁,z₁,ω) is the sound pressure at x₁,y₁,z₁ for the single frequency ω,

$$cos ϕ = \frac{{z}_{1} - {z}_{0}}{Δ r} ,$$

where

Δr=\sqrt{(x₁−x₀)²+(y₁−y₀)²+(z₁−z₀)²}.

giving the relation between the pressure distribution on a plane z₀ and z₁. Using this equation, the wave field at any position z₁ can be synthesized if the pressure field at the recording plane z₀ is known.

After Fourier transformation with respect to x and y, the Rayleigh II integral (1) can be written as:

\tilde{P}(kₓ,k_{y},z₁,ω)=\tilde{P}(kₓ,k_{y},z₀,ω)·e^{±jk}^{_{z}}^{|z}^{₁}^{-z}^{₀}^{|}, (2)

### or in 2-D,

\tilde{P}(kₓ,z₁,ω)=\tilde{W}(kₓ,Δz,ω)\tilde{P}(kₓ,z₀,ω) (3)

where,

\tilde{W}(kₓ,Δz,ω)=e^{jkΔz}, in the case of forward (away from the source) extrapolation or,

\tilde{W}(kₓ,Δz,ω)=e^{-jkΔz}, in the case of inverse (towards the source) extrapolation.

Where kₓ=ω/cₓ k_{y=ω/c}_{y} and k_{z}=ω/c_{z}. The parameters cₓ, c_{y} and c_{z} represent the apparent velocities in the x-, y-, and z-direction respectively.

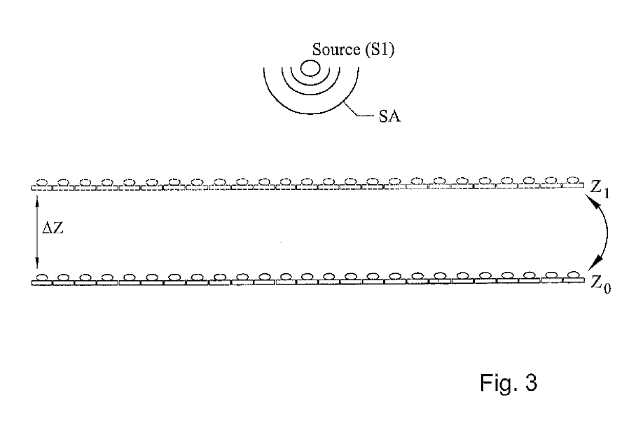

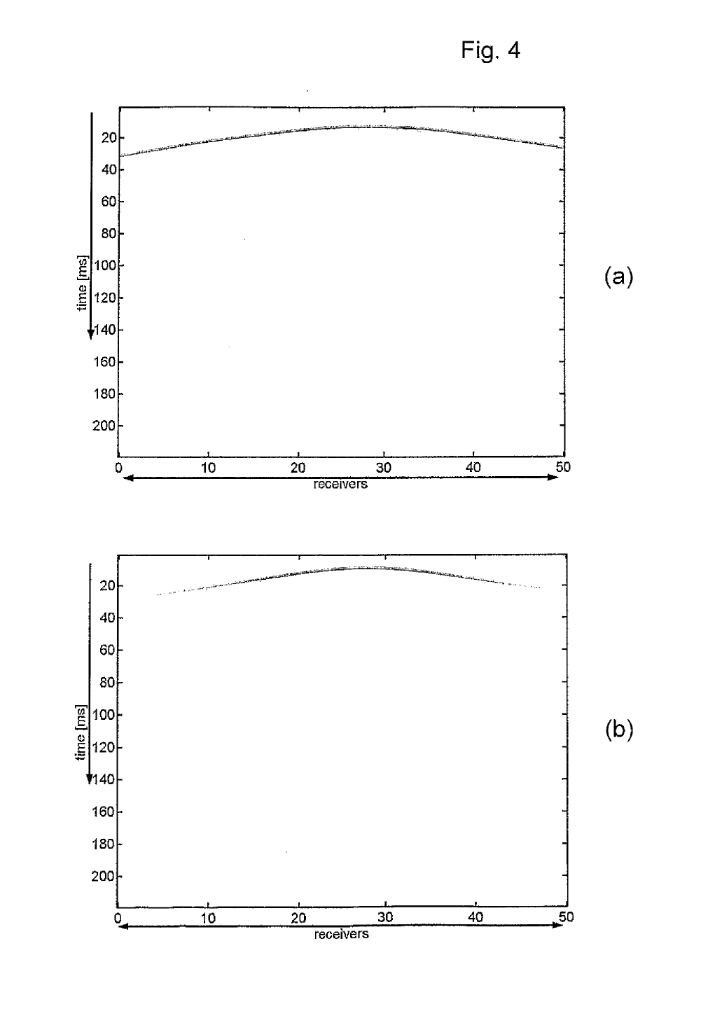

This equation gives us a simple relation of the pressure distribution between two planes with a distance Δz (delta z). In practice the operator W is a discrete matrix containing the discrete extrapolation operators for all relevant combinations between plane z₀ and z₁. In particular, FIG. 3 shows a wave field extrapolation according to an embodiment of the present invention, in which a source S1 from which an acoustic signal SA originates is received by an array located originally in plane z0. In the inverse wavefield extrapolation, the plane z0 is moved a distance delta z towards the source S1 to plane z1. FIG. 4 shows examples of inverse wave field extrapolations according to an embodiment of the present invention. In particular, FIGS. 4a)-d) show the result of the inverse wave field extrapolation for an impulse response source and a linear array of receivers 2. The first image a) shows the recorded data at the receiver array(s). The other images b)-c) show the result of the wave field for a virtual array closer to the source. The last image (d) is the result of a ‘virtual’ array beyond the source.

This ‘inverse wave field extrapolation’ technique can be applied to any recorded wave field. By stepping through the medium, thus calculating the data for a ‘virtual’ array of receivers moving through the area of interest, the wave field (in time and space) can be computed.

### Finding the Source Locations (Step 24)

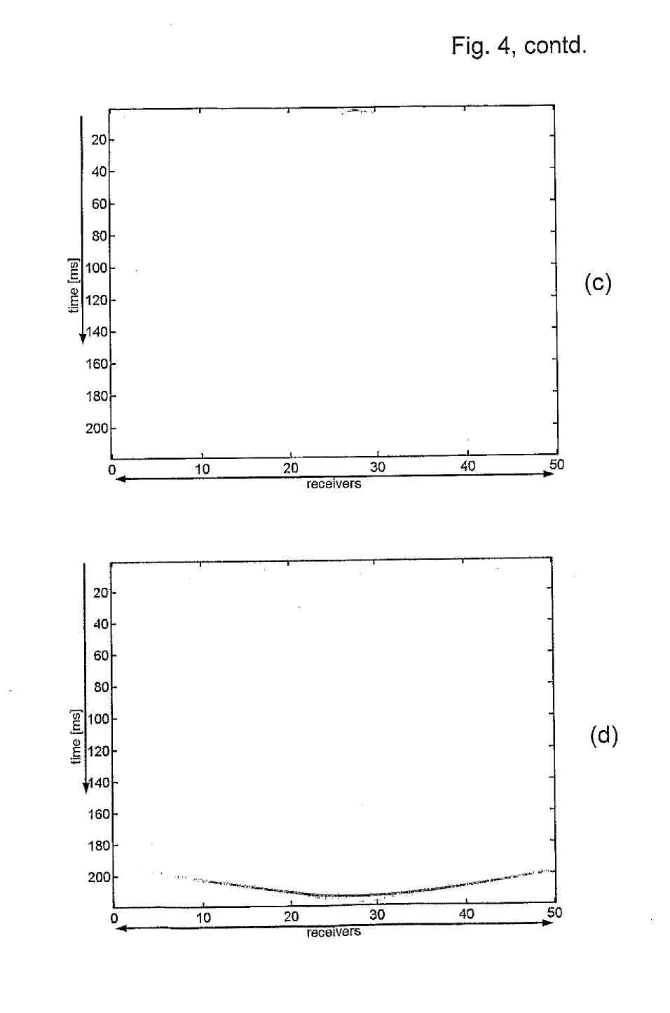

FIGS. 5a) and b) show an example of a wave field extrapolation and source localisation. Combining all data of the ‘inverse wave field extrapolation’ for all virtual receiver 2 positions gives a 3-D data matrix, giving the data in space (2-D) and time (1-D). Physically wave field extrapolation can be seen as moving the array along the z-direction, see FIG. 3. When the source array coincides with the source, the signal is recorded at zero time, 3^{rd} frame in FIG. 5a. Conventional imaging techniques select the zero-time sample after wave field extrapolation. However speech signals are usually more continuous signals, instead of pulse-shaped signals. In this case it is more appropriate to compute the energy after wave field extrapolation to find the source location.

Using this technique according to an embodiment of the invention, the source locations can be found for a certain time interval. In case of moving sources 6 this can be repeated for every time interval. or partially overlapping time intervals.

The wave field extrapolation may be carried out in various domains, i.e., the space-time domain, the space-frequency domain or the wavenumber-frequency domain. It has been found that the wavenumber-frequency domain provides a high efficiency. To further improve the speed of the tracking algorithm, only a few relevant (high) frequency components may be used.

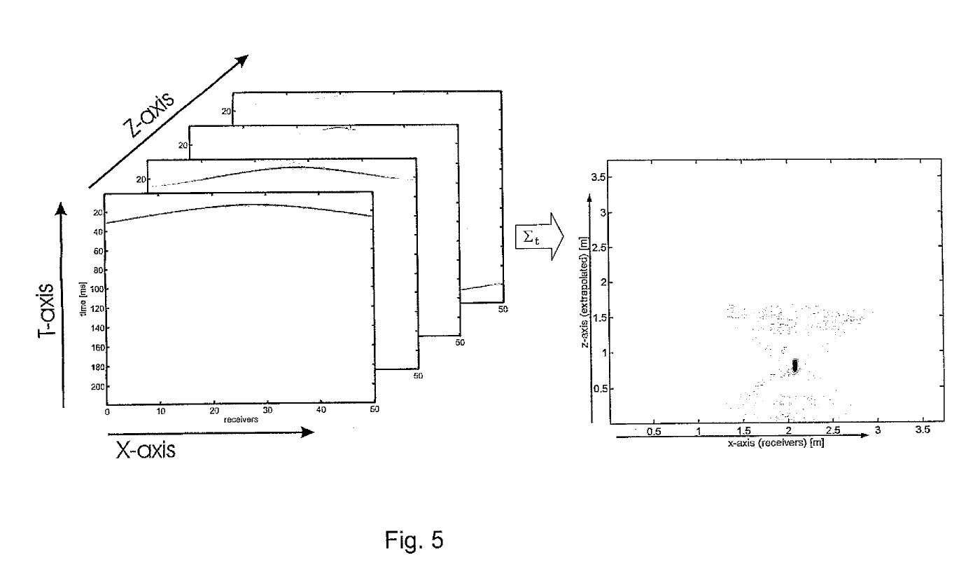

The relevant frequencies are those frequencies, clearly present in the source signal. For every timestep Δτ (delta tau), the source locations are stored. This position information is used to follow a specific source and to register which source is speaking (or emitting sound) at which position in space and during which time interval. Optionally, interpolation over distance with respect to the signal amplitude may be used to find the maximum. FIG. 6 shows an example of a source localization according to one embodiment of the invention using a) all frequencies and according to a further embodiment of the invention using b) the high frequencies only. It can be seen that by comparing FIGS. 6a) and 6b) the source locations are more readily found where only the higher frequency components are used.

### Focussing Using Delay and Sum (Step 26 and 28)

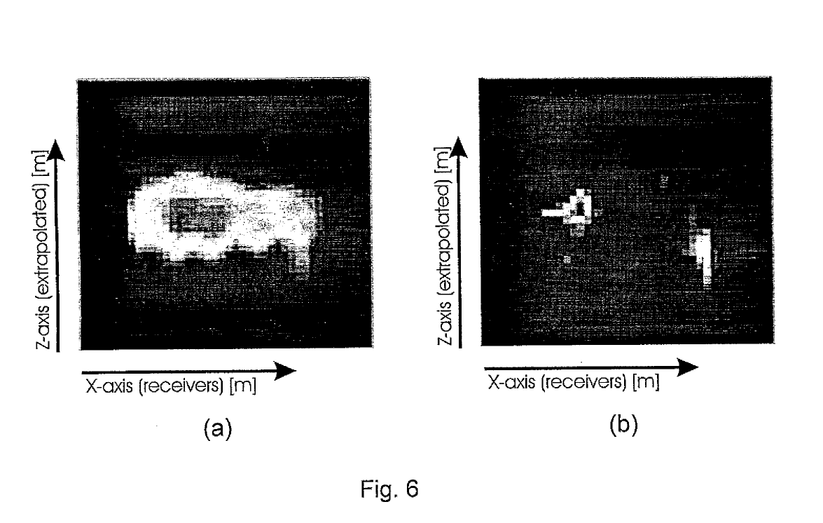

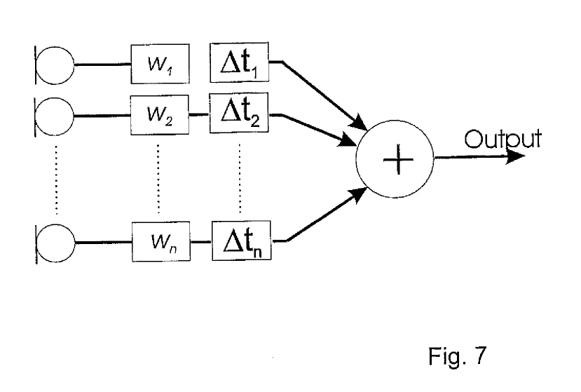

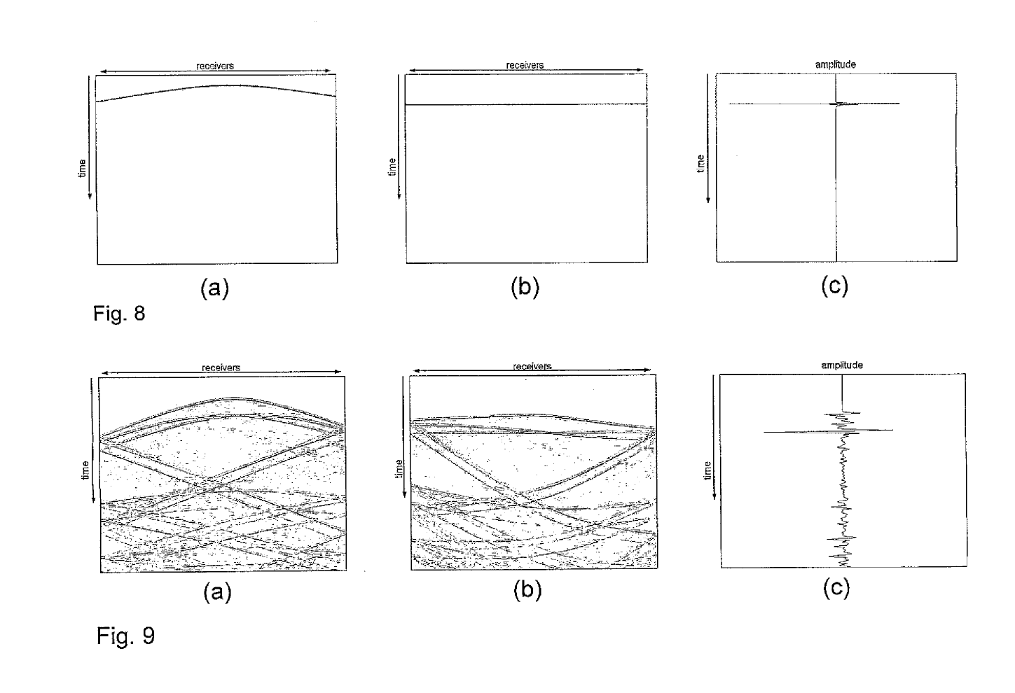

With the known positions of the sources, a first estimate of the source signals can be obtained by summing the signals after applying a weighting and a delay-time for every source-receiver combination, this technique is known as delay and sum. With the delay and sum technique the direct wave is constructively summed for all receiver signals as illustrated in FIG. 7. FIG. 7 shows a delay and sum technique according to an embodiment of the present invention. FIG. 8 shows an example of a delay and sum technique used in accordance with an embodiment of the present invention; In practice, the enclosure as defined by the environment 1 around the source S1, S2 . . SN gives (multiple) reflections, deteriorating the result after focussing, as can be seen in FIG. 9. FIG. 9 shows an example of a delay and sum technique used in a conventional technique. In particular, FIG. 9 shows an example of a delay and sum method with an extensive leakage of unwanted signals. As seen in FIG. 9, stacking the right hand side result leads to leakage of the undesired signals. Comparing FIG. 8 and FIG. 9 shows that in practice that the conventional delay and sum technique will never perform very well, due to multiple reflections causing leakage. In the example shown in FIG. 9 of three simultaneous speech sources in an enclosure, the maximum suppression of undesired signals is 14 dB.

Estimating the Impulse Response (W) (step 30)

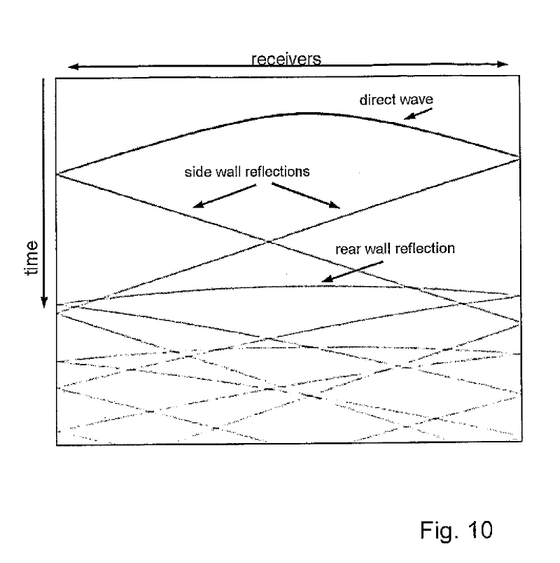

Using equation (2), and the estimated (focussed) source signal, an estimation can be made of the impulse response W. In one embodiment, the impulse response may be estimated for a direct wave. In an alternative embodiment, the impulse response may be estimated for the Green's function of the room. This is done for every source-receiver combination, In the embodiment, where the impulse response is the Green's function, the impulse response W is estimated by deconvolution of the estimated source signal S over the receiver signal P. After deconvolution, a pulse-shaped signal is obtained. This result is shown in FIG. 10 in the space time domain. In particular, FIG. 10 shows an impulse response of a source in an enclosed environment according to an embodiment of the present invention.

The various wave fronts can now be identified. Hence the impulse response of the room 1 can be obtained without prior knowledge of the room itself. Alternatively information about the room can be used to construct an impulse response, for a given source location.

### Least Squares Estimation Based Inversion (Step 34)

The result can be yet further improved when the energy of the reflections, deteriorating the focussing result, is included in the estimation of the source signal.

The relation between the receivers and the source is given by:

P(x,ω)=W(x,107 ) [symbol] S(x,ω) [symbol] P(kₓ,ω)=\tilde{W}(kₓ,ω)S(kₓ,ω), (4)

where P(x,ω) is the pressure recorded on the receivers in time, W(x,ω) is the transfer function for every source-receiver combination and S(x,ω) is the source signal. The convolution in the space domain results in a multiplication in the wavenumber domain.

For a single frequency, m receivers and it sources; equation (1) can be written in a discrete form as a matrix vector multiplication by:

$$[ \begin{matrix}P ( {x}_{1} ) \\ \\ P ( {x}_{m} )\end{matrix} ] = [ \begin{matrix}W ( {x}_{1} , {s}_{1} ) & … & W ( {x}_{1} , {s}_{n} ) \\ ⋮ & ⋱ & ⋮ \\ W ( {x}_{m} , {s}_{1} ) & … & W ( {x}_{m} , {s}_{n} )\end{matrix} ] [ \begin{matrix}S ( {s}_{1} ) \\ ⋮ \\ S ( {s}_{n} )\end{matrix} ] , \qquad ( 5 )$$

where P(xₘ) is the pressure at receiver m, S(sₙ) is the source signal of source n, and W(xm,sn) is the transfer function between source n and receiver m, for a single frequency ω.

The improvement of the method is the least squares inversion of equation (5), as expressed by the following equation:

S(x,ω)=(W^{t}ₑₛₜWₑₛₜ+λI)⁻¹W^{t}ₑₛₜP(x,ω). (6)

where λ is the stabilization factor and I is the identity matrix. Alternative methods for solving equation 5 may also be envisaged.

This equation adds (W^{t}ₑₛₜWₑₛₜ+λI)⁻¹, providing a deconvolution in space, in contrast to the conventional delay and sum technique, where only S(x,ω)=W^{t}ₑₛₜP(x,ω)is used. Advantages achieved by the invention include improved separation of the source signals and the flexibility of using sparse arrays.

It has been found that the method of the present invention, as embodied in the system and method of the present invention, provides good results in localizing and tracking multiple sources simultaneously, separating the speech signal of the plurality of sources with a suppression of undesired signals in the order of 25 dB, while conventional methods provide a suppression in the order of 14 dB.

Moreover this method, also as embodied in the system, is very flexible in handling signals from a plurality of sources.

Whilst specific embodiments of the invention have been described above, it will be appreciated that the invention may be practiced otherwise than as described. The description is not intended to limit the invention.

1. A system for extracting one or more acoustic signals from a plurality of source signals emitted by a plurality of sources, respectively, in an environment, the system comprising a plurality of microphone receivers for receiving the one or more acoustic signals from the environment and transmitting the signal to a signal processor, wherein the signal processor is arranged to estimate the plurality of source signals using the data received by the plurality of receivers, the signal processor is further arranged to perform an operation on the data received by the plurality of receivers with the estimated source signals to provide an estimate of the propagation operator of the environment, wherein the data received by the plurality of receivers is input to the estimate of the impulse response of the environment to provide an output comprising a plurality of channels, wherein one or more of the channels correspond to the one or more acoustic signals from one of the plurality of sources, respectively.

2. A system according to claim 1, wherein the propagation operator is described as a direct wave.

3. A system according to claim 1, wherein the propagation operator is described as an impulse response.

4. A system according to claim 1, wherein the operation is to deconvolve the data received by the array of receivers with the estimated source signals.

5. A system according to claim 1, wherein the one or more acoustic signals are extracted simultaneously.

6. A system according to claim 1, wherein signal processor is arranged to locate a plurality of source locations of at least one of the plurality of sources for a plurality of time intervals, respectively, the system further comprising a memory for storing the plurality of source locations for the respective time intervals.

7. A system according to claim 6, wherein the signal processor is arranged to track one or more moving sources by repeatably locating the one or more moving sources for at least one of a plurality of time intervals and partially overlapping time intervals.

8. A system according to claim 6, wherein the stored location data is used to track a particular source and to register which source is emitting the one or more acoustic signal at which position in space and during which time interval.

9. A system according to claim 1, wherein the sources are located using inverse wavefield extrapolation to form an image.

10. A system according to claim 9, wherein the signal processor is arranged to find the plurality of sources in the image.

11. A system according to claim 9, wherein the inverse wavefield extrapolation is carried out with a predetermined range of frequency components at the higher end of the frequency range of the one or more signals.

12. A system according to claim 9, wherein the inverse wavefield extrapolation is carried out in the wavenumber-frequency domain.

13. A system according to claim 1, wherein the signal processor is arranged to focus the plurality of sources to obtain a plurality of focussed sources.

14. A system according to claim 13, wherein the estimated source signals are obtained by using the plurality of focussed sources.

15. A system according to claim 1, wherein the one or more acoustic signals are extracted by inputting the data received from the array with the estimate impulse response and carrying out a least squares estimation for the plurality of sources.

16. A system according to claim 1, wherein at least one of the plurality of channels is input to an application.

17. A system according to claim 16, wherein the application is at least one of a speech recognition system and a speech controlled system.

18. A system according to claim 1, wherein the plurality of receivers are arranged as one or more arrays of receivers.

19. A method of extracting one or more acoustic signals from a plurality of source signals emitted by a plurality of sources, respectively, in an environment, wherein a signal processor is arranged to receive the one or more acoustic signals from the environment from a plurality of microphone receivers which transmit the signal to the signal processor, the method comprising estimating the plurality of source signals using the data received by the plurality of receivers, performing an operation on the data received by the plurality of receivers with the estimated source signals to provide an estimate of a propagation operator of the environment and inputting the data received by the plurality of receivers into the estimate of the propagation operator of the environment to provide an output comprising a plurality of channels, wherein one or more of the channels correspond to the one or more acoustic signals from one of the plurality of sources, respectively.

20. A method according to claim 19, wherein the estimating step estimates the propagation operator as a direct wave.

21. A method according to claim 19, wherein the estimating step estimates the propagation operator as an impulse response of the environment.

22. A method according to claim 19, wherein the operating is deconvolving the data received by the array of receivers with the estimated source signals.

23. A method according to claim 19, including simultaneously extracting the one or more acoustic signals.

24. A method according to claim 19, including locating a plurality of source locations of at least one of the plurality of sources for a plurality of time intervals, respectively, the method further comprising storing the plurality of source locations for the respective time intervals.

25. A method according to claim 24, including tracking one or more moving, sources by repeatably locating the one or more moving sources for at least one of a plurality of time intervals and partially overlapping time intervals.

26. A method according to claim 24, including using the stored location data to track a particular source and registering which source is emitting the one or more acoustic signal at which position in space and during which time interval.

27. A method according to claim 19, locating the sources in an image formed using inverse wavefield extrapolation.

28. A method according to claim 27, carrying out the inverse wavefield extrapolation with a predetermined range of frequency components at the higher end of the frequency range of the one or more signals.

29. A method according to claims 27, including carrying out the inverse wavefield extrapolation in the wavenumber-frequency domain.

30. A method according to claim 19, including extracting the one or more acoustic signals by inputting the data received from the array with the estimate impulse response and carrying out a least squares estimation for the plurality of sources.

31. A method according to claim 19, including inputting the at least one of the plurality of channels to an application.

32. A user terminal comprising means operable to perform the method of claim 19.

33. A computer-readable storage medium storing a program which when run on a computer controls the computer to perform the method of claim 19.
